(19) United States
(12) Patent Application Publication
(10) Pub. No.: US 2008/0220711 A1
(43) Pub. Date: Sep. 11, 2008

(54) Ventilation device

(75) Inventors: Thomas Banschbach, Osterburken (DE); Ralf Kern, (US)

Correspondence Address: Sandra J. Thompson, 335 Knoch Knolls Rd, Naperville, IL, 60565, US

(73) Assignee: Aurora Konrad G. Schulz GmbH & Co. KG

(21) Appl. No.: 11/700,483

(22) Filed: Jan. 31, 2007

(30) Foreign Application Priority Data
Mar. 3, 2006 (DE) 10 2006 010 388.2

(51) Int. Cl. B60H 1/34

(52) U.S. Cl. 454/155

(57) ABSTRACT

The device has an air nozzle (10) with an adjustable air vent, where the nozzle is closable using a slide or a shutoff flap (28). A manual operating unit of the air vent is arranged adjacent to the front side of the air nozzle. The slide or flap is electrically or manually adjustable using two positioning units (40, 44) in a selective manner. The air nozzle has a frame (20) that is used for mounting an electric motor. A faceplate (26) is arranged on the frame and has recesses (34) for an operating unit. A connection area for an air pipe of the air vent is modularly formed. An independent claim is also included for an air nozzle for a ventilation device.

The invention relates to a ventilation device for vehicles in accordance with the preamble of claim 1.

Numerous ventilation devices have already been disclosed for vehicles, in particular for large-capacity vehicles, such as coaches, in which use is made of air nozzles which conduct the air provided by a central air supply unit to the supply points. In many cases, it is desirable for the passengers of the large-capacity vehicle each to be able to adjust the nozzles intended for them, to be precise in particular with respect to the air-dispensing direction, but also with respect to the quantity of air. Examples of this include the known ball valve nozzles which permit both pivoting and regulation of the quantity of air.

However, in some cases, it is instead desirable to remotely control certain operating parameters of the nozzle. This applies, for example, to nozzles which are arranged in a manner such that they can be difficult to reach, or their dispensing of air is not to be controlled by a passenger but rather, for example, by the driver of the large-capacity vehicle.

For the remote control in particular of the air-dispensing direction, both Bowden cables and electric motors have been proposed. The pivoting angle of slats can thereby be set. However, this solution has the disadvantage that the central air supply unit, which frequently has at least one heat exchanger for providing hot air and/or cooled air, requires additional space for shutoff members and air quantity regulators. It is precisely when, for example, the ventilation device is realized as a front heater in constricted space conditions that additionally required space has to be paid for by the air hoses having narrower radii of curvature, which is unfavorable in terms of the flow.

Furthermore, a compact air controller has already been proposed which can also be incorporated into the operation of the central supply unit and for this purpose has servomotors which are responsible both for the discharging direction and also for the air quantity supply and can be set in a manner controlled by a central computer.

However, this solution has not proven successful, since it is comparatively complicated but nevertheless requires an additional shutoff element for closing the nozzle in question, which can be fitted either to the nozzle or in the vicinity of the central air supply unit. In this case, particular care then also has to be taken to ensure that a contradictory position between the shutoff element and the air quantity flap does not arise.

The nozzles used hitherto are relatively less flexible, so that for every application a special nozzle has to be produced, i.e. the corresponding slats or other air-guiding elements, the frame of the nozzle and the further elements. This is highly costly particularly in the case of large-capacity vehicles having comparatively low series piece numbers and also requires an immense amount of storage for the supply of replacement parts.

The invention is therefore based on the object of providing a ventilation device according to the preamble of claim 1, which permits the simplified design but nevertheless can be used in a particularly flexible manner.

This object is achieved according to the invention by claim 1. Advantageous developments emerge from the subclaims.

In the case of the ventilation device according to the invention, there is a slide which is closeable by motor or a flap which is closeable by motor, is arranged closely adjacent to the air nozzle itself and also permits complete closing of the supply of air under remote control. Separate closing members on the central supply unit can thus be omitted. In addition, it is provided that the discharging direction of the air can be set in any desired manner via vents having slats, to be precise irrespective of the position in which the shutoff slide according to the invention or the shutoff flap is in.

However, it is particularly favorable for the shutoff slide according to the invention or the shutoff flap according to the invention to be able to be configured such that actuation is possible either by the motor or by a manual actuating element. For this purpose, a correspondingly designed adjusting element is provided preferably on each end side of the flap, the adjusting element being connected or not being connected to the manual actuating element or to the motor depending in each case on the use of the air nozzle. For example, the shutoff flap may be formed as an injection molded part, and a small pin may be formed on the side facing away from the motor, said pin remaining free during motorized operation of the blocking flap and only coming into use if a manual actuating element for the shutoff flap is provided, for example next to the air outlet of the nozzle.

Furthermore, on the motor side the shutoff flap may have a clutch which is intended for the engagement of a drive shaft of the servomotor. The clutch enters into operation if the motor is used, and otherwise remains inoperative.

According to the invention, in this context, the modular design of the air nozzle is particularly favorable. For example, the same injection molds can be used for the frame irrespective of whether a manual or electrical activation of the shutoff flap is desired. For manual activation, a knurled wheel is mounted in a manner known per se on an axle stub of the frame in such a manner that it projects forward, partially extending through a correspondingly designed slot in the panel which covers the frame. The knurled wheel is connected via an actuating lever to the manual adjusting element of the shutoff flap, which adjusting element is designed, for example, as a pin and extends outward parallel to the axis of rotation of the shutoff flap, but at a distance therefrom.

If the shutoff flap is actuated exclusively by means of an electric motor, the knurled wheel and the lever are immediately rendered superfluous, so the manual adjusting element does not have any function. In this configuration, the panel is then designed as a continuous panel which covers the slot in the frame for the abovementioned knurled wheel. By contrast, in the case of this use of the air nozzle according to the invention, the motorized adjusting element of the shutoff flap is in operation. Said adjusting element can be designed, for example, as a noncircular recess coaxial with respect to the axis of rotation of the shutoff flap and can be appropriately designed for the engagement of a corresponding noncircular shaft, for example a shaft with a flattened portion, of the servomotor. Instead of this, a clutch or any other suitable configuration for transmitting torque between servomotor and shutoff flap may also be realized.

In a modified, particular configuration, both adjusting elements may also be in operation, in which case an additional sliding clutch is preferably then realized for the servomotor, so that the manual actuation has priority.

It is particularly favorable for the air nozzle according to the invention to be able to be realized as an air vent for a vehicle window, but also as a “personal vent” or as a ventilation nozzle for the foot well, which is frequently unsuitable for manual actuation, but can also be realized for the co-driver of the large-capacity vehicle or else for a cab. By completely separating the blocking function for the air from the setting of the flow direction, the air nozzle can be blocked and opened irrespective of the angle of adjustment of the slats. This also results in a large pivoting range for the airflow, for example horizontally over approximately 60° and vertically over more than 100°.

The connecting region for the air hose of the air nozzle according to the inventions is also of modular design. By means of an adapter, for example a 90° deflection can readily be realized in a compact-manner, with the adapter then expediently partially engaging over the frame, in order to provide as little installation depth as possible, and being fastened there.

Further advantages, details and features emerge from the description below of an exemplary embodiment of the invention with reference to the drawing, in which:

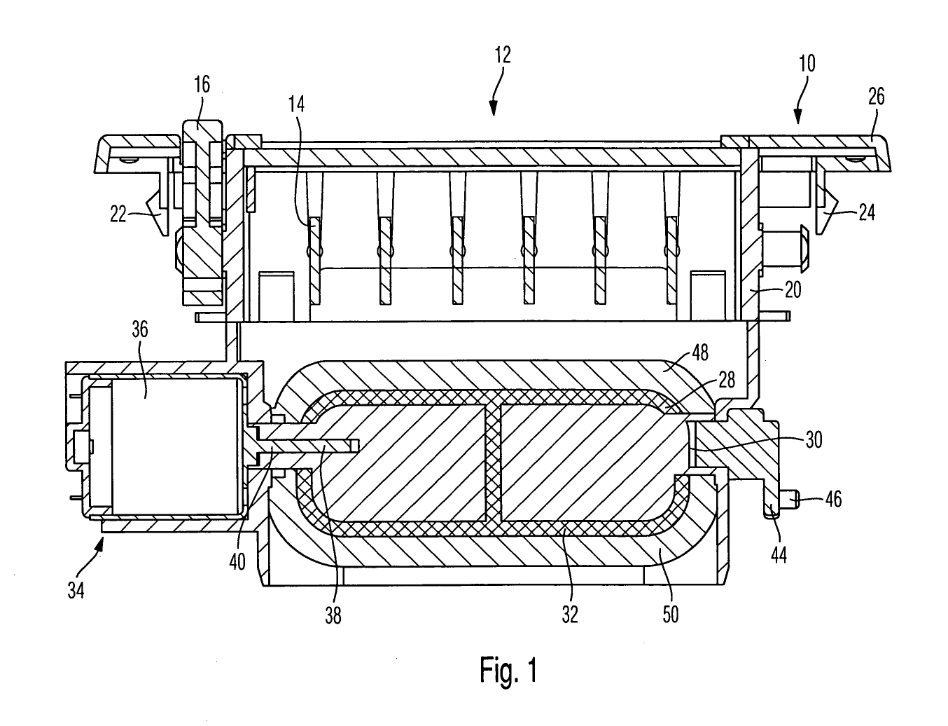

FIG. 1 shows a section through an embodiment of an air nozzle according to the invention in the opened position of the shutoff flap;

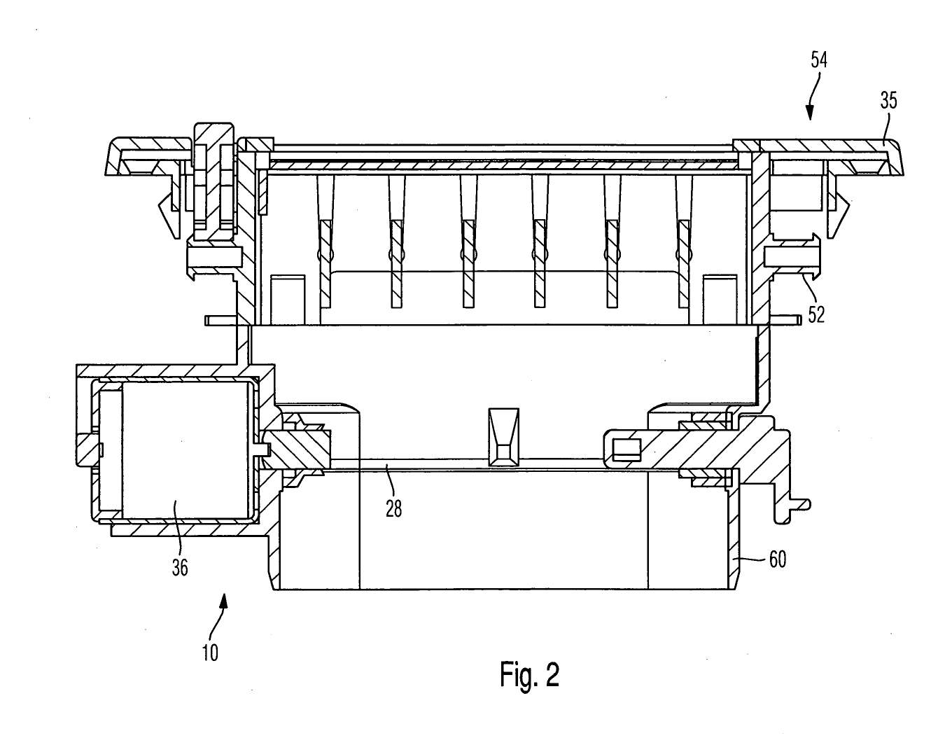

FIG. 2 shows the embodiment according to FIG. 1, with the shutoff flap closed; and

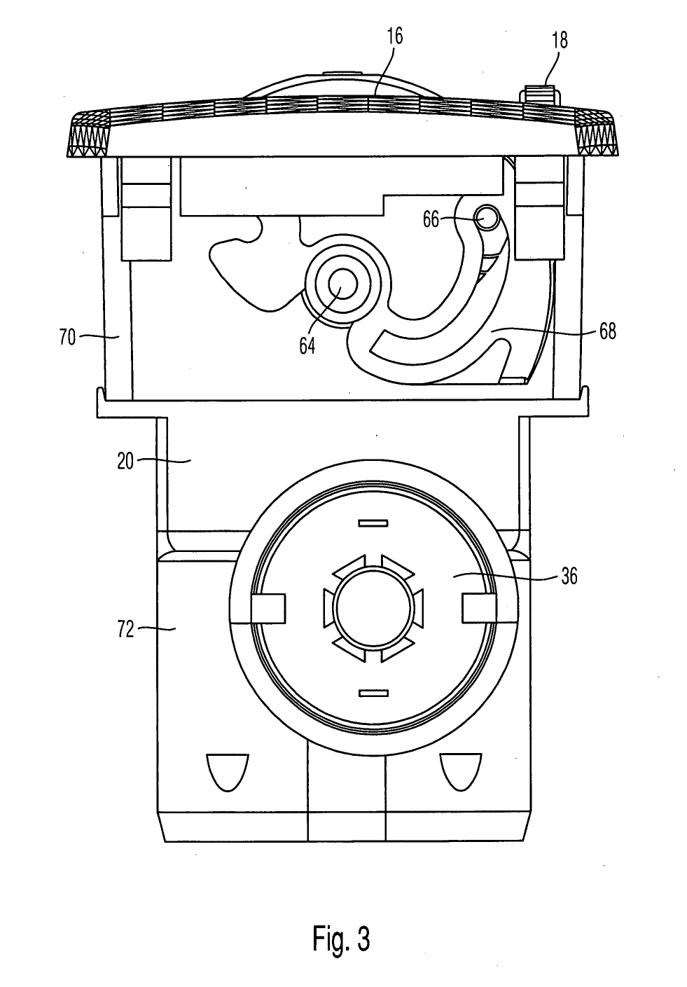

FIG. 3 shows an end view of the embodiment according to FIGS. 1 and 2.

The air nozzle 10 illustrated in FIG. 1 is part of a ventilation device for a vehicle, in which said air nozzle is provided a number of times. The air nozzle 10 has a vent 12 with slats 14 which can be actuated manually via a knurled wheel 18, which is apparent from FIG. 3, Slats (not apparent from FIG. 1) which extend transversely with respect to the slats 14 and can be actuated via a further knurled wheel 16 are additionally provided. A discharging angle of the vent 12 can be set within wide ranges by the knurled wheels 16 and 18.

The air nozzle 10 has a frame 20 which, inter alia, bears the slats 14 and the knurled wheels 16 and 18. It is provided in a manner known per se flush with the installation surface and fits into a body cutout. The frame 20 can snap onto the body cutout in question via latching tongues 22 and 24. In addition, it is covered on the front side by a panel 26 which leaves a recess for the vent 12.

Furthermore, the frame 20 bears a shutoff flap 28 which is mounted in the frame 20 in a manner such that it can pivot about an axis of rotation 30. The shutoff flap 28 can be pivoted in a manner known per se through approximately 90°, between the open position illustrated in FIG. 1 and the closed position illustrated in FIG. 2. It preferably has an encircling sealing lip in order to ensure full sealing. In addition, a reinforcing rib 32 is incorporated which makes it possible to provide adequate strength with a comparatively thin material thickness.

The frame 20 furthermore has a motor recess 34. An electric servomotor 36 can be accommodated in the motor recess 34 in a protected manner and in a manner appropriate for the external dimensions of the motor 36. The motor 36 has a flattened shaft stub 38. The shaft stub 38 extends coaxially with respect to the axis of rotation 30 of the shutoff flap 28. It engages in an adjusting element 40 of the shutoff flap 28, which is designed as a noncircular recess appropriate for the shaft stub 38. The shutoff flap 28 can thereby be adjusted as desired via the drive of the servomotor 36.

Furthermore, the shutoff flap 28 has a manual adjusting element 44. The manual adjusting element 44 extends opposite the adjusting element 40 and likewise through the axis of rotation 30 of the shutoff flap 28. In the exemplary embodiment illustrated, it is designed as a separate component with a pin 46 which is eccentric in relation to the axis of rotation 30. The introduction of a torque to the pin 46 makes it possible for the shutoff flap 28—as an alternative to actuation by the motor 36—to likewise be pivoted.

In the exemplary embodiment illustrated, the shutoff flap 28 is of a symmetrical design. It has a somewhat shorter wing 48 and a somewhat longer wing 50, with the pin 46 extending into the region of the longer wing 50. This configuration has structural advantages and permits a more compact arrangement.

The embodiment illustrated in the figures makes it possible, instead of the motorized actuation of the shutoff flap 28, also to provide manual actuation. For this purpose, the frame has a bearing pin 52. The bearing pin 52 is determined for receiving a further knurled wheel (not illustrated here) which passes through the panel 26 in a region 54. Accordingly, to realize this configuration, a modified panel 26 is provided which has a corresponding recess. When the need arises, a panel of this type can also be realized by means of a punching tool, and so an additional injection mold is not required. Alternatively, a recess of this type can also be realized by means of a corresponding insert in the injection mold.

In addition, for manual actuation, an actuating lever is provided which acts eccentrically on the knurled wheel (not illustrated) and engages around the pin 46. By means of this solution, manual actuation of the shutoff flap can be ensured.

It is apparent from FIG. 2 that the shutoff flap 28 can also extend in the plane of the drawing, so that it then blocks off the airflow through the air nozzle 10 according to the invention. Below the adjusting elements, the frame 20 has a flange 60 which is intended for the connection of an adapter. The adapter serves to deform the airflow between the generally round air hose and the essentially rectangular cross section of the air nozzle 10.

It is apparent from FIG. 3 that the knurled wheel 16 is also mounted pivotably. For this purpose, a further bearing pin 64 is provided, and the multiple arrangement of slats can be actuated by means of the knurled wheel 16 via a driver 66 with a slotted guide 68, while the slats can be actuated via the knurled wheel 18, which likewise has corresponding drivers which are known per se.

The somewhat eccentric arrangement of the motor 36 is also apparent from FIG. 3. This arrangement is caused by the asymmetrical configuration of the shutoff flap 28.

It is also apparent from FIG. 3 that the frame 20 can be of two-part design. The vent frame 70 is the installation base while, depending on the configuration, the blocking-flap frame 72 permits either a rectilinear or an angled supply of air. The rectilinear supply of air is illustrated in FIG. 3.

1. A ventilation device for vehicles, with an air nozzle which has an in particular adjustable vent and can be closed via a slide or a flap, with a manual actuating member being arranged adjacent to the vent on the front side of the air nozzle, wherein the slide or the flap has two adjusting elements (40,44) via which the slide or the flap (28) can be adjusted either electrically or manually.

2. The ventilation device as claimed in claim 1, wherein one adjusting element (40) is arranged on one side of a flap and the other adjusting element (44) is arranged on the other side of the flap, in each case adjacent, but eccentrically, to the pivot axis.

3. The ventilation device as claimed in claim 1, wherein the air nozzle (10) has a frame (20) which is provided for the attachment of an electric motor (36).

4. The ventilation device as claimed in claim 3, wherein a panel (26) which has recesses (34) for actuating elements is arranged on the frame (20).

5. The ventilation device as claimed in Claim 3, wherein the frame (20) is designed as a snap-type frame for snapping into a body opening and in particular has latching tongues for mounting on the body opening, and wherein the frame (20) is covered by a panel (26) which has a recess (34) for the vent (12).

6. The ventilation device as claimed in claim 3, characterized in that a hose connection can be fixed to the frame (20) and permits additional air to be supplied to the air nozzle (10).

7. The ventilation device as claimed in claim 1, characterized in that the vent (12) has slats (14) which are mounted adjustably in two spaced-apart planes, the slats (14) of each orientation being jointly adjustable via an adjusting wheel.

8. The ventilation device as claimed in claim 1, wherein the flap (28) extends asymmetrically about its longitudinal axis, with the longer wing (50) pointing toward the direction of flow of the air in the opened state of the flap (28).

9. An air nozzle for a ventilation device as claimed in claim 1.
